(19) United States
(12) Patent Application Publication
(10) Pub. No.: US 2026/0235495 A1
(43) Pub. Date: Aug. 13, 2026

(54) SYSTEMS AND METHODS FOR MUELLER MATRIX IMAGING

(71) Applicant: PRESIDENT AND FELLOWS OF HARVARD COLLEGE, Cambridge, MA (US)

(72) Inventors: Muhammad Aun Abbas Zaidi, Cambridge, MA (US); Noah A. Rubin, Cambridge, MA (US); Federico Capasso, Cambridge, MA (US)

(73) Assignee: PRESIDENT AND FELLOWS OF HARVARD COLLEGE, Cambridge, MA (US)

(21) Appl. No.: 19/470,793

(22) PCT Filed: Mar. 29, 2024
(86) PCT No.: PCT/US2024/022287

§ 371 Date: Sep. 29, 2025

Related U.S. Application Data
(60) Provisional application No. 63/456,413, filed on Mar. 31, 2023.

(51) Int. Cl. G01N 21/21; G01J 4/04

(52) U.S. Cl. CPC G01N 21/21; G01J 4/04; G01N 2201/0683

(57) ABSTRACT

A system can include a polarization state generator. The polarization state generator can illuminate an object with a spatially varying polarization distribution. The system can include a polarization state analyzer. The polarization state analyzer can receive light from the object. The system can include at least one processor. The at least one processor can acquire a plurality of images from the polarization state analyzer in a single measurement in time. The at least one processor can obtain a spatially varying Mueller matrix comprising one or more polarization properties of the object.

### CROSS-REFERENCE TO RELATED PATENT APPLICATION

This application claims the benefit and priority of U.S. Provisional Patent Application No. 63/456,413, filed on Mar. 31, 2023, the entirety of which is incorporated by reference herein.

### GOVERNMENT RIGHTS

This invention was made with government support under FA9550-21-1-0312 awarded by U.S. Air Force Office of Scientific Research (AFOSR). The government has certain rights in this invention.

### TECHNICAL FIELD

The present application relates generally to imaging utilizing a structured light.

### BACKGROUND

Polarization can be a fundamental property of light. Polarization can be defined as the direction of oscillation of the light's electric field. Polarization can be a design degree of freedom and a source of additional information. Polarization can be of interest and utility to both fundamental science and technological innovation. The generation, manipulation, sensing, and imaging of polarization can be important because of the potential of polarization to reveal rich information about the physical properties of objects, materials and their structures, which can be indiscernible to other optical techniques. To fully understand the role of polarization in probing physical quantities, the framework used to describe polarization and its transformations can be defined. Polarization can be represented by a four-component vector, known as a Stokes vector. Consequently, linear interaction of light with a sample (e.g., object, object of interest) can be fully described by a 4×4 matrix, known as a Mueller matrix (MM). Polarization transforming properties of an object, such as its retardance, diattenuation, polarizance and depolarization, can all be computed directly from its Mueller matrix. Mueller matrix imaging polarimetry (e.g., Mueller imaging) can capture images of the spatially varying Mueller matrix elements of a sample or object of interest. Mueller matrix imaging polarimetry can provide the most complete image of an object's polarization properties. Mueller matrix imaging polarimetry can reveal information which would otherwise be invisible to or unobtainable by intensity-only imaging.

### SUMMARY

The most general polarization transformation of light, as a result of its linear interaction with an object, can be described by the object's 4×4 Mueller matrix. Mueller matrix imaging polarimetry can be an important technique in science and technology to image the spatially varying polarization response of an object of interest and to reveal rich information otherwise invisible to traditional imaging. The systems and methods of the present disclosure, in some embodiments, are directed to a compact and minimalist Mueller matrix imaging system. The system can include a metasurface to produce structured polarization illumination. The system can include a metasurface for polarization analysis. The system can acquire images for all sixteen components of an object's spatially varying Mueller matrix in a single shot. The system can be free of any moving parts or bulky polarization optics. The system can enable and empower applications in real-time medical imaging, material characterization, machine vision, target detection, and other areas.

At least one aspect of the present disclosure is directed to a system. The system can include a polarization state generator. The polarization state generator can illuminate an object with a spatially varying polarization distribution. The system can include a polarization state analyzer. The polarization state analyzer can receive light from the object. The system can include at least one processor. The at least one processor can acquire a plurality of images from the polarization state analyzer in a single measurement in time. The at least one processor can obtain a spatially varying Mueller matrix. The spatially varying Mueller matrix can include one or more polarization properties of the object.

Another aspect of the present disclosure is directed to a method. The method can include illuminating, by a polarization state generator, an object with a spatially varying polarization distribution. The method can include receiving, by a polarization state analyzer, light from the object. The method can include acquiring, by at least one processor, a plurality of images from the polarization state analyzer in a single measurement in time. The method can include obtaining, by the at least one processor, a spatially varying Mueller matrix. The spatially varying Mueller matrix can include one or more polarization properties of the object.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a system for polarization generation and imaging, according to an embodiment.

FIG. 2 illustrates polarization optics.

FIG. 3 illustrates a metasurface, according to an embodiment.

FIG. 4 illustrates polarization responses, according to an embodiment.

FIG. 5 illustrates images corresponding to an object's Mueller matrix image, according to an embodiment.

FIG. 6 illustrates spatially sampling of an object with different incident polarization states, according to an embodiment.

FIG. 7 illustrates different Stokes components making up incident polarization states and an output Stokes vector, according to an embodiment.

FIG. 8 illustrates a 4f imaging system used to image the Mueller matrix of an object, according to an embodiment.

FIG. 9 illustrates an image produced by the system of FIG. 8, according to an embodiment.

FIG. 10 illustrates a full-Stokes image, according to an embodiment.

FIG. 11 illustrates reference images for amplitude demodulation, according to an embodiment.

FIG. 12 illustrates measured Mueller matrix images of a thin-film linear polarizer, according to an embodiment.

FIG. 13 illustrates measured Mueller matrix images of a zero-order quartz quarter-wave plate, according to an embodiment.

FIG. 14 illustrates measured Mueller matrix images of a zero-order quartz half-wave plate, according to an embodiment.

FIG. 15 illustrates measured Mueller matrix images of a half-wave plate, according to an embodiment.

FIG. 16 illustrates a chiral beetle illuminated by right circularly polarized light and left circularly polarized light, according to an embodiment.

FIG. 17 illustrates a raw image of a chiral beetle captured using Mueller matrix imaging, according to an embodiment.

FIG. 18 illustrates a full-Stokes image computed from the raw image of FIG. 17, according to an embodiment.

FIG. 19 illustrates a Mueller matrix image from the full-Stokes image of FIG. 18, according to an embodiment.

FIG. 20 illustrates a method of Mueller matrix imaging, according to an embodiment.

Like reference numbers and designations in the various drawings indicate like elements.

### DETAILED DESCRIPTION

Following below are more detailed descriptions of various concepts related to, and implementations of, methods, apparatuses, and systems for Mueller matrix imaging. The various concepts introduced above and discussed in greater detail below may be implemented in any of a number of ways, as the described concepts are not limited to any particular manner of implementation. Examples of specific implementations and applications are provided primarily for illustrative purposes.

Mueller matrix imaging can be used in various imaging applications, such as in biology and medicine. Some examples can include the use of Mueller matrix imaging for disease diagnostics, retinal imaging, glucose sensing, bacteria detection, identification of malignant tissues, differentiation between healthy and cancerous tissues (cancerous tissues, for instance, can exhibit different depolarization and retardance signatures than healthy tissues), and for discerning between different types and stages of cancers. The use of Mueller matrix imaging can be used in areas such as ellipsometry, oceanic sciences, turbidity, and target detection. Despite the advantages and utility of Mueller matrix imaging, its widespread adoption can be been hampered by the relative complexity, bulk, cost, and hardware limitations of some implementations.

The systems and methods of the present disclosure can use metasurface optics for a compact, single-shot, and complete Mueller matrix imaging system that overcomes the limitations of other Mueller matrix imaging implementations. The systems and methods of the present disclosure can provide a pathway for the widespread adoption of Mueller matrix imaging to empower applications that use advanced imaging or sensing modalities.

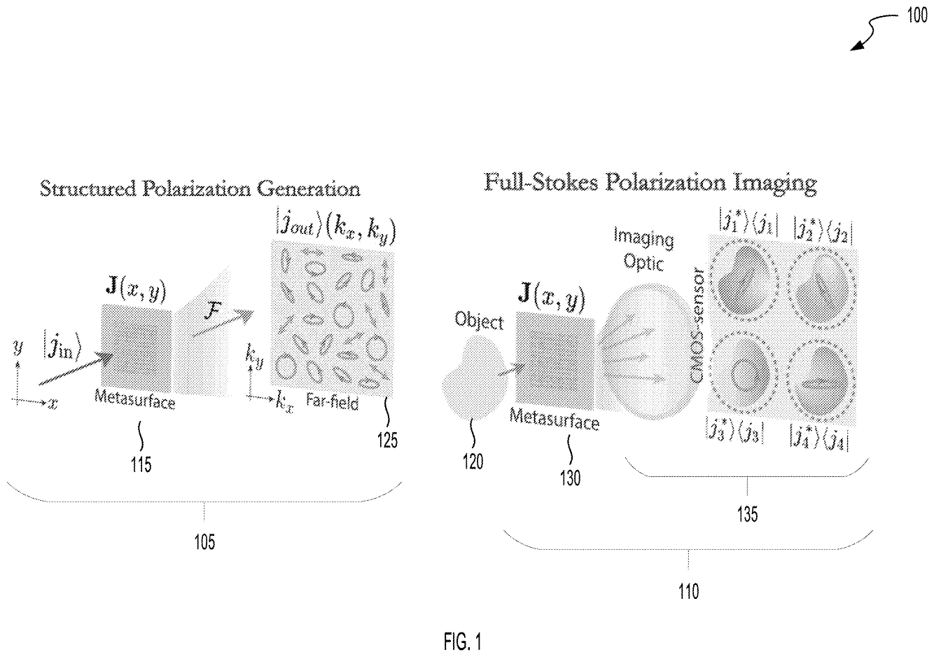

FIG. 1 illustrates a system 100 (e.g., imaging system, Mueller matrix imaging system, imaging apparatus, imaging device). The system 100 can be for polarization generation and imaging. The system 100 can include a portion 105 for polarization generation. For example, the portion 105 can be for structured polarization generation. The system 100 can include a portion 110 for polarization imaging. For example, the portion 110 can be for full-Stokes polarization imaging. The system 100 can be for imaging in transmission or reflection. The system 100 can include a single shot Mueller imaging system. The system 100 can enable Mueller matrix imaging. The system 100 can be wavelength agnostic. The device can have a length in a range of 1 mm to 3 mm. The device can have a width in a range of 1 mm to 3 mm.

The system 100 can include one or more polarization state generators (PSG) 115. The polarization state generator 115 can illuminate an object 120 (e.g., object of interest, target object) with a polarization distribution 125. For example, the polarization state generator 115 can illuminate the object 120 with a spatially varying polarization distribution 125. The spatially varying polarization distribution 125 can include a polarization distribution that varies spatially. The spatially varying polarization distribution 125 can be equal to or proportional to

$$( \begin{matrix}1 \\ \sqrt{\frac{2}{3}} cos ( 0.5 m π ) cos ( n π ) \\ \sqrt{\frac{2}{3}} sin ( 0.5 m π ) cos ( n π ) \\ \sqrt{\frac{1}{3}} cos ( m π )\end{matrix} ) ,$$

where (m, n) are discrete spatial coordinates. The polarization distribution can include light with spatially varying polarization. The spatially varying polarization distribution 125 can have a uniform intensity. The spatially varying polarization distribution 125 can have a non-uniform intensity. The spatially varying polarization distribution 125 can include a plurality of polarization states. A polarization state can be defined by the relative phase and relative amplitude of light. The polarization state can include polarized light. The polarization state can include circularly or elliptically polarized light. The spatially varying polarization distribution 125 can include at least four different polarization states. The spatially varying polarization distribution 125 can include spatially varying polarization states. The spatially varying polarization distribution 125 can include a polarization distribution that varies spatially. For example, the polarization distribution 125 can be different for different positions. The polarization state generator 115 can generate a spatially varying grid of polarizations.

The polarization state generator 115 can include a metasurface (e.g., first metasurface, metasurface 1). The polarization state generator 115 can be implemented by designing a metasurface polarization hologram that generates a spatially varying (e.g., structured) polarization illumination in the far-field. The polarization state generator 115 can include a spatial light modulator. The object 120 can be placed in the far-field or a focal length away from a converging lens to interact with the structured illumination.

A light source can illuminate the metasurface with non-structured light. The metasurface can produce structured light from the non-structured light. The structured light can have a spatially varying polarization illumination in the far-field.

The system 100 can include one or more polarization state analyzers (PSA) 130. The polarization state analyzer 130 can receive light from the object 120. The light can include polarized light (e.g., circularly polarized light, linearly polarized light). The polarization state analyzer 130 can include a metasurface (e.g., second metasurface, metasurface 2). The metasurface can have diameter in a range of 0.25 mm to 10 mm. The can include an array of nanopillars. The nanopillars can have a height in a range of 100 nm to 1000 nm. The polarization state analyzer 130 can image the resultant fields from the object 120.

In some embodiments, the light from the object 120 is diffracted by the metasurface of the polarization state analyzer 130 onto separate regions of a light sensor. The light sensor may include a CMOS sensor. Each separate region of the light sensor may correspond to a polarization of light. The intensity of each polarization of light may correspond to the amount of light on a corresponding sensor region.

The system 100 can include at least one processor 135. The at least one processor 135 can acquire a plurality of images. For example, the at least one processor 135 can acquire a plurality of images from the polarization state analyzer 130. The at least one processor 135 can acquire a plurality of images from the polarization state analyzer 130 in a single measurement in time. For example, the at least one processor 135 can acquire the plurality of images in a single shot. The at least one processor 135 can acquire the plurality of images at one time. The plurality of images can include sixteen images corresponding to the spatially varying Mueller matrix. For example, the plurality of images can include sixteen images corresponding to a 4×4 Mueller matrix. The Mueller matrix can describe how the object 120 transforms polarization. The at least one processor 135 can include an imaging optic. The at least one processor 135 can include a complementary metal oxide semiconductor (CMOS) sensor.

The at least one processor 135 can obtain a Mueller matrix. For example, the at least one processor 135 can obtain a spatially varying Mueller matrix. The spatially varying Mueller matrix can include one or more polarization properties of the object 120. The one or more polarization properties of the object 120 can include spatially varying polarization properties. The one or more polarization properties of the object 120 can include the polarization response of the object 120. For example, the one or more polarization properties of the object 120 can include the polarization response of the object under different polarizations. The spatially varying Mueller matrix can be described by the polarization properties of the object 120. The spatially varying Mueller matrix can include a Mueller matrix that varies spatially. The Mueller matrix can include different components (e.g., chiral component, linear component, etc.). The Mueller matrix can fully describe how an object will change the polarization state of a beam of light upon interaction. The object's polarization properties can be described by the Mueller matrix. The polarization properties of the object can include its degree of polarization, retardance, and diattenuation. Each polarization property can correspond to a different polarization. The polarization response can include the polarization of light after the incident light has interacted with the object. The polarization response can be spatially varying. The polarization response can be different for different incident polarizations.

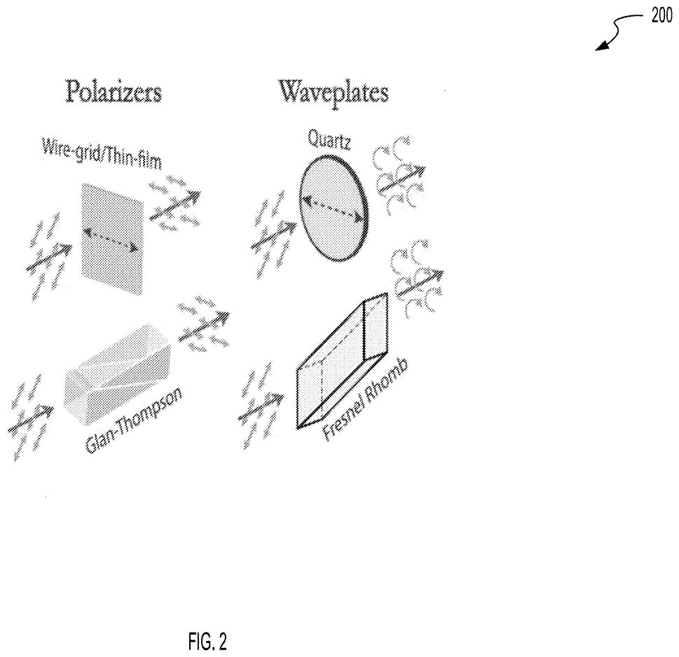

FIG. 2 illustrates polarization optics. Polarization optics can include polarizers and waveplates. Polarization optics, such as wire-grid/thin-film polarizers and quartz crystal waveplates can transform the incident polarization owing to the bulk polarization response of their constituent elements. These components may only allow a limited set of polarization transformations. These components may not provide spatial control over the output polarization. Micro-patterning and liquid crystals may provide spatial polarization control, but have their own sets of limitations. For example, micro-patterning can be limited to linear-only polarization transformations, and can have poor spatial resolution. Liquid crystals can often require multiple passes to address different states of polarization, needing space and introducing complexity. As a result, Mueller matrix imaging implementations relying on these components can suffer from limitations. For instance, a Mueller matrix imaging implementation can use the division-of-time approach where the sample is sequentially illuminated with and analyzed for different polarization states, in order to compute the entire Mueller matrix. This approach, because of its finite time resolution, can be infeasible for real-time imaging applications. Such an implementation can use multiple components and moving parts, which can add to the bulk, cost, and complexity of the system. To mitigate these challenges, in particular the problem of time resolution, partial Mueller matrix imaging implementations (where only a select few components of the Mueller matrix are computed) and hybrid implementations (including a mix of spatial and temporal control) can be used. A truly single-shot and complete Mueller matrix imaging implementation has remained elusive.

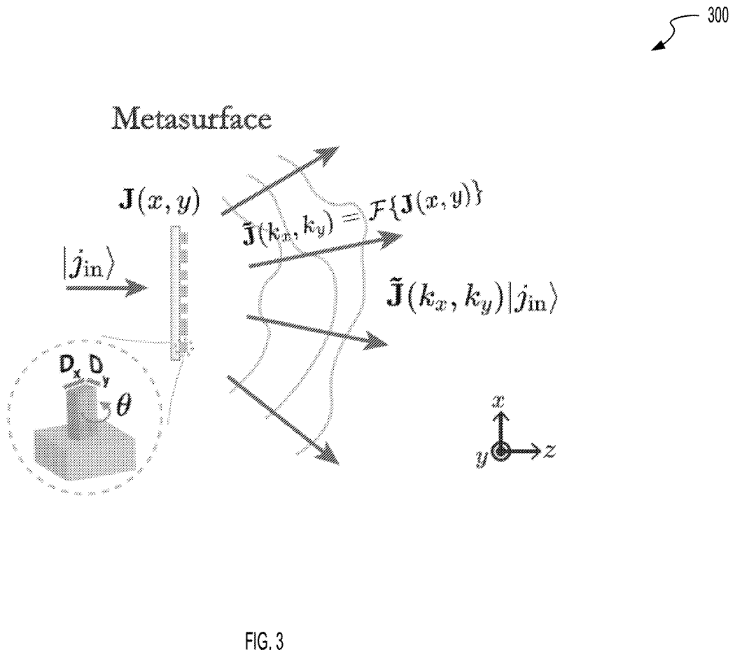

FIG. 3 illustrates a metasurface 300. The metasurface 300 can include subwavelength-spaced arrays of phase-shifting nanopillars. The metasurface 300 can provide complete spatial control over polarization transformations. The metasurface 300 can outperform technologies such as micro-patterning and liquid crystals, in resolution, form-factor, efficiency and multi-functionality. The metasurface 300 can be mathematically described as a spatially varying Jones matrix of the form shown in Equation 1:

$$J ( x , y ) = R ( - θ ( x , y ) ) [ \begin{matrix}{e}^{i {∅}_{x} ( x , y )} & 0 \\ 0 & {e}^{i {∅}_{y} ( x , y )}\end{matrix} ] R ( θ ( x , y ) ) \qquad ( 1 )$$

where (x, y) are spatial coordinates, and R(θ) is the 2×2 rotation matrix. The three degrees of freedom at each (x, y)—θ(x, y), φ_{X}(x, y), φ_{Y}(x, y)—can be directly related to the shape, including the length (Dₓ), width (D_{y}), orientation (θ), and height (kept constant) of the local nanopillar, exhibiting strong structural birefringence. As seen in Equation 1, the metasurface 300 can locally performs unitary (e.g., lossless) transformations only, but through interference, its far-field response can be both unitary and/or Hermitian (e.g., lossy). Engineering the far-field (e.g., a region starting some wavelengths away from the aperture and extending all the way to infinity) to perform user specified polarization transformations can be of utility because of its ease of access, for instance by choosing a suitable operating distance or using a lens. For a metasurface with a spatially varying Jones matrix J(x, [symbol] ), the polarization response in the far-field can be most succinctly described as \tilde{J}(kₓ, [symbol] )= [symbol] {J(x, [symbol] )}, using matrix Fourier optics, where [symbol] is the element-wise 2D spatial Fourier transform operator. A metasurface profile J(x, [symbol] ) can be optimized using algorithms such as gradient descent or phase retrieval, to perform any conceivable polarization transformations \tilde{J}(kₓ [symbol] ) in the far-field. Each nanopillar within the metasurface 300 can provide three degrees of freedom: pillar length Dₓ, pillar width D_{y} and pillar orientation θ. The metasurface 300 can include thousands of nanopillars in either a periodic or an aperiodic arrangement. The metasurface 300 can have many degrees of freedom which can optimized for a user-specified polarization response.

The metasurface 300 can be designed to generate spatially varying states of polarization for a given incident polarization as shown in FIG. 1. The spatially varying states of polarization can include user-specified spatially varying states of polarization or target spatially varying states of polarization. The metasurface 300 can be used for structured polarization generation. Structured polarization generation can be defined, for an incident polarization state |jᵢₙ [symbol] , the far-field output |jₒᵤₜ [symbol] (kₓ, k_{y}), given by \tilde{J}(kₓ, k_{y})|jᵢₙ [symbol] , following a user-specified polarization distribution.

The metasurface 300 can be designed to analyze four different polarization states in separate diffraction orders for full-Stokes imaging as shown in FIG. 1. Due to their versatility, metasurfaces can provide a platform for compact, single-shot and complete Mueller matrix imaging. The metasurface 300 can be designed to function as a polarization analyzer with a Hermitian (e.g., lossy) Jones-matrix response \tilde{J}=|j*(kₓ, k_{y} [symbol] [symbol] j(kₓ, k_{y})|, in the far-field. The metasurface 300 (e.g., periodic metasurface) can perform full-Stokes imaging. For example, the metasurface 300 can split the incoming light into its first four diffraction orders and simultaneously analyze for four different polarization states alongside an imaging lens and a sensor.

The polarization structured illumination (e.g., defined by Equation 1) can allow the individual components of the incident Stokes-vector to act as carrier frequencies (e.g., spatial carrier frequencies), which can be amplitude modulated by the object Mueller components. Assuming the Mueller components have band-limited spectra, each Mueller component can be fully retrieved from the resulting Stokes image by amplitude demodulation and low-pass filtering. In practice, because of the presence of sharp edges and/or cut-offs, the Fourier spectrum of the Mueller components would not be limited, but if the spectrum is concentrated around low spatial frequencies, artifacts due to aliasing can be minimal. Thus, the structured polarization illumination alongside full-Stokes imaging can allow for the simultaneously acquisition of images for all Mueller components. This can enable real-time Mueller imaging in a compact setting.

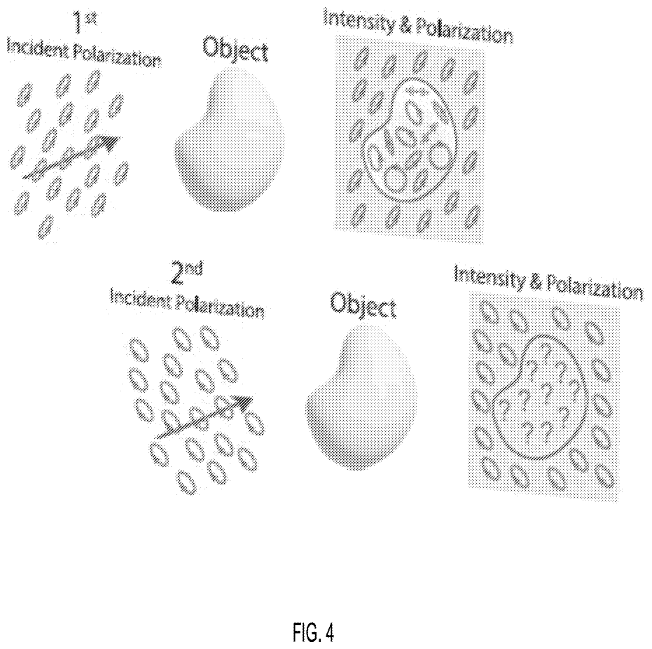

A photograph or an image of a non-luminous object can describe the spatially varying intensity distribution of transmitted or reflected light under some external illumination. Full-Stokes imaging, of the type shown in FIG. 1, can describe both the intensity and polarization distribution over the entire field of view. However, the resulting polarization image may be incomplete in describing the polarization properties of an object of interest. An object may transmit or reflect a certain distribution of intensity and polarization, given an incident polarization (e.g., distribution), which can then be imaged by a full-Stokes camera. However, it might produce a completely different intensity and polarization response under a different set of incident polarizations, as shown in FIG. 4. FIG. 4 illustrates polarization responses. For a given incident polarization, an object, in general, can produce a spatially varying intensity and polarization response in transmission or reflection, which can be imaged by, for instance, a full-Stokes camera. For a different incident polarization, the object may produce a completely different intensity and polarization response.

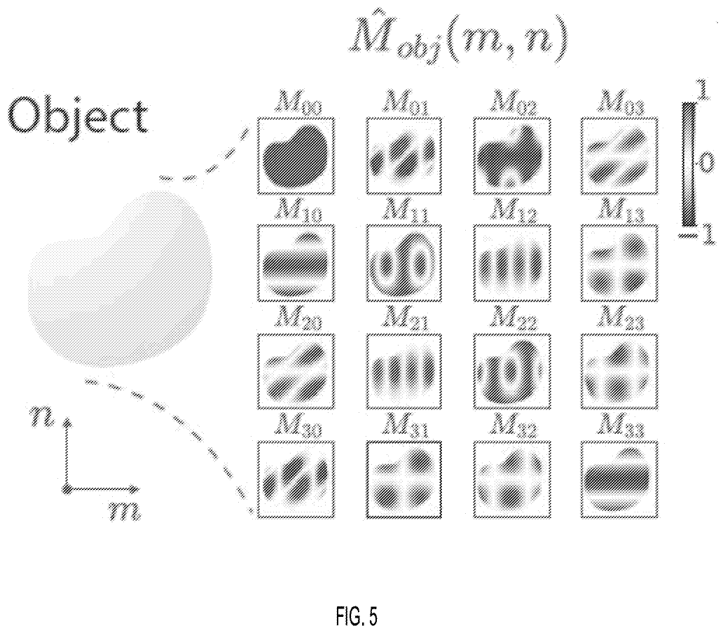

A complete polarization image can include an image that describes the response of an object to a given incident polarization and/or all possible incident polarizations. This can include a 4×4 Mueller matrix image, as shown in FIG. 5. FIG. 5 illustrates images corresponding to an object's Mueller matrix image. An object that may appear invisible or ordinary under standard intensity-only imaging, may show rich contrast and distinct features in its Mueller matrix image. To fully quantify the spatially varying polarization properties of an object, a set of 16 images that correspond to its 4×4 Mueller matrix image can be calculated. An object can reveal rich contrast in different components of its Mueller matrix image, making it much easier to classify.

In some embodiments, a partial Mueller matrix may be calculated. Specifically, rather than a 4×4 Mueller matrix image, a 2×2 Mueller matrix image may be utilized. The 2×2 Mueller matrix image may use only RHP and LHP circular polarizations. The 2×2 Mueller matrix image may use only right-handed circular polarization (RHCP) and left-handed circular polarization (LHCP). Further, a 2×3 Mueller matrix image may be utilized. The 2×3 Mueller matrix image may only include linear polarizations. The object 120 can be illuminated with circularly polarized light. For example, the object 120 can be illuminated with circularly polarized light from the polarization state generator 115. The polarization state analyzer 130 can receive linearly polarized light from the object 120. For example, the polarization state analyzer 130 can receive axis-aligned polarized light or diagonally polarized light. The object 120 can be illuminated with linearly polarized light. For example, the object 120 can be illuminated with linearly polarized light from the polarization state generator 115. The polarization state analyzer 130 can receive circularly polarized light from the object 120.

For a single-shot and complete Mueller matrix imaging system, the information to compute all the 16 images that make up a Mueller matrix image may need to be acquired in a single measurement in time. To do this, the object can be illuminated with a spatially varying polarization distribution of the form shown in Equation 2:

$${\vec{S}}_{in} ( m , n ) = ( \begin{matrix}1 \\ \sqrt{2 / 3} cos ( 0.5 m π ) cos ( n π ) \\ \sqrt{2 / 3} sin ( 0.5 m π ) cos ( n π ) \\ \sqrt{1 / 3} cos ( m π )\end{matrix} ) \qquad ( 2 )$$

where (m, n) are discrete spatial coordinates.

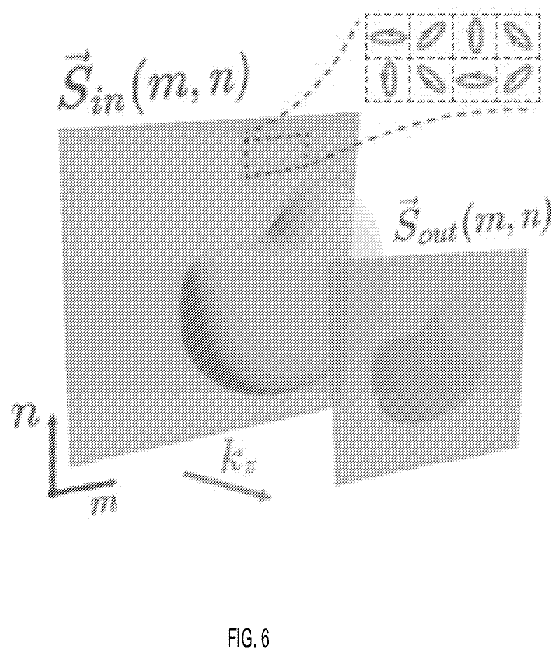

The fast Fourier transform (FFT) can be used in the computation. A CMOS-sensor can be used in the measurement. The FFT and CMOS-sensor can use discrete spatial coordinates. The formulation can be described in terms of discrete spatial coordinates. The polarization distribution defined in Equation 2 can include four different polarizations. The four different polarizations can make up the vertices of a tetrahedron inscribed within the Poincare sphere, arranged in a 2×4 repeating unit cell, as shown in FIG. 6. FIG. 6 illustrates spatially sampling of an object with different incident polarization states. The object can be spatially sample (as opposed to temporally sampled) with a minimum of four different incident polarization states \vec{S}ᵢₙ(m, n), where the resulting polarization distribution \vec{S}ₒᵤₜ(m, n)=\hat{M}_{obj}(m, n)\vec{S}ᵢₙ(m, n) can be imaged by a full-Stokes camera.

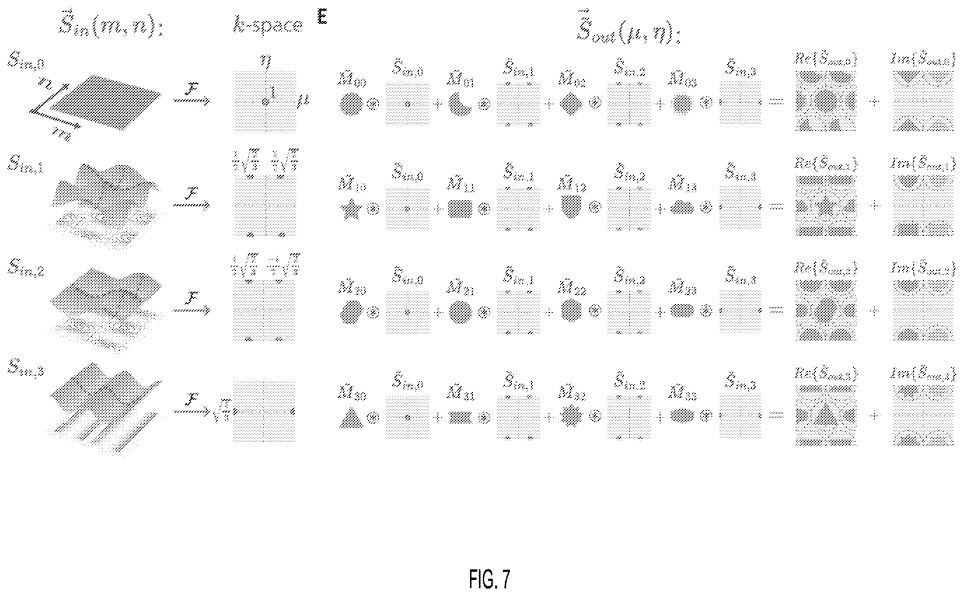

FIG. 7 illustrates different Stokes components making up incident polarization states and an output Stokes vector. The choice of the structured polarization illumination may be the one shown in Equation 2. From Equation 2, the individual Stokes components of the structured polarization illumination can include sinusoids in the spatial domain and delta functions in the Fourier domain or k-space, as shown in FIG. 7. The different Stokes components that up make the incident polarization states can be spatially varying and orthogonal sinusoids with different spatial frequencies and thus non-overlapping delta functions in the Fourier-domain.

Equation 3 describes an object whose polarization properties are described by its spatially varying Mueller matrix:

$${\hat{M}}_{obj} ( m , n ) = ( \begin{matrix}{M}_{00} ( m , n ) {M}_{01} ( m , n ) {M}_{02} ( m , n ) {M}_{03} ( m , n ) \\ {M}_{10} ( m , n ) {M}_{11} ( m , n ) {M}_{12} ( m , n ) {M}_{13} ( m , n ) \\ {M}_{20} ( m , n ) {M}_{21} ( m , n ) {M}_{22} ( m , n ) {M}_{23} ( m , n ) \\ {M}_{30} ( m , n ) {M}_{31} ( m , n ) {M}_{32} ( m , n ) {M}_{33} ( m , n )\end{matrix} ) \qquad ( 3 )$$

When the structured polarization illumination (Equation 2) interacts with the object (Equation 3), the resulting output Stokes vector can be described as Equation 4:

$${\vec{S}}_{out} ( m , n ) = ( \begin{matrix}{M}_{00} + {M}_{01} \sqrt{2 / 3} cos ( 0.5 m π ) cos ( n π ) + \\ {M}_{02} \sqrt{2 / 3} sin ( 0.5 m π ) cos ( n π ) + {M}_{03} \sqrt{1 / 3} cos m π \\ {M}_{10} + {M}_{11} \sqrt{2 / 3} cos ( 0.5 m π ) cos ( n π ) + \\ {M}_{12} \sqrt{2 / 3} sin ( 0.5 m π ) cos ( n π ) + {M}_{13} \sqrt{1 / 3} cos m π \\ {M}_{20} + {M}_{21} \sqrt{2 / 3} cos ( 0.5 m π ) cos ( n π ) + \\ {M}_{22} \sqrt{2 / 3} sin ( 0.5 m π ) cos ( n π ) + {M}_{23} \sqrt{1 / 3} cos m π \\ {M}_{30} + {M}_{31} \sqrt{2 / 3} cos ( 0.5 m π ) cos ( n π ) + \\ {M}_{32} \sqrt{2 / 3} sin ( 0.5 m π ) cos ( n π ) + {M}_{33} \sqrt{1 / 3} cos m π\end{matrix} ) \qquad ( 4 )$$

where, while displaying Equation 4, the (m, n) dependence of the Mueller components can be omitted.

From Equation 4, the amplitudes of the different spatial carrier waves given by the Stokes elements defined in Equation 2 can be modulated independently by the different Mueller matrix components. This amplitude modulation can be understood in k-space, by studying the Fourier spectra \tilde{\vec{S}}ₒᵤₜ(μ, η)—where (μ, η) are the k-space coordinates, analogues to spatial coordinates (m, n)—of the output Stokes vector, defined in terms of convolutions involving the Fourier spectra of the Mueller matrix components, and the incident Stokes elements.

As seen in FIG. 7, the spectra of every Mueller matrix component can be shifted (e.g., by the Fourier shift theorem) to separate locations or channels in k-space, where these channels are centered on the delta functions given by the spectra of the incident Stokes elements. To avoid any overlap between neighboring spectra of the Mueller matrix components (e.g., aliasing), the separation between two neighboring channels can be at least twice the maximum spatial frequency of the spectra of the Mueller matrix components centered on those channels (e.g., Nyquist theorem). If the spectra of each Mueller matrix component is indeed band-limited and within the Nyquist limit, the image of each Mueller matrix component can be retrieved without any loss of information. This can be accomplished by the amplitude demodulation of the signal(s) in \vec{S}ₒᵤₜ (Equation 4). Thus, if \vec{S}ₒᵤₜ can be acquired in a single measurement, all the Mueller matrix components can also be computed in a single measurement. This can result in a single-shot and complete Mueller matrix imaging system.

\vec{S}ₒᵤₜ(m, n)=\hat{M}_{obj}(m, n)\vec{S}ᵢₙ(m, n), instead of multiplication (e.g., matrix multiplication), can be described in terms of convolutions by describing the computation in the Fourier domain. The Fourier spectra of the different components of the object's Mueller matrix, \hat{M}_{obj}(m, n), can shift to the location of the different delta functions corresponding to the spectra of the different incidents Stokes components. This can be due to the convolution operation. If the spectra of the Mueller components are sufficiently band-limited, they can be filtered from the resulting Stokes image. This can allow for the reconstruction of \hat{M}_{obj}(m, n) without any loss of information.

The single-shot and complete Mueller matrix imaging system can include structured polarization illumination and full-Stokes imaging. Structured polarization illumination can be achieved using metasurface 1. Full-Stokes imaging can be achieved using metasurface 2. Metasurface 1 can generate \vec{S}ᵢₙ(m,n) (Equation 2), and metasurface 2 can analyze \vec{S}ₒᵤₜ(m,n) (Equation 4) in a single-shot, from which the Mueller matrix image, \hat{M}_{obj} (m, n) (Equation 3), can be computed using the principles described above. Metasurface 1 and metasurface 2, having separate functionalities, can be computationally optimized using different algorithms. Metasurface 1 and metasurface 2 can be fabricated using the same method. The fabricated metasurfaces can include of TiO₂ nanopillars. The nanopillars can be designed to work with different wavelengths. For example, the nanopillars can be designed to work with the visible spectrum. However, the design principles described herein are wavelength agnostic. Metasurface 1 can include an aperiodic arrangement of roughly 4000 nanopillars, with each pillar separated from another by a sub-wavelength distance of 420 nm. Metasurface 1 can be roughly 1.68 mm in diameter. The structured polarization illumination or hologram (e.g., with a divergence angle θ_{div} of ±40° can diverge quickly. A converging lens can be used to access its far-field. Metasurface 2 can include a periodic arrangement of 12×12 arrays of nanopillars separated by 420 nm. Metasurface 2 can be approximately 3 mm in diameter. Metasurface 2 can have a larger diameter than metasurface 1, which can allow for more light to pass through the aperture for imaging.

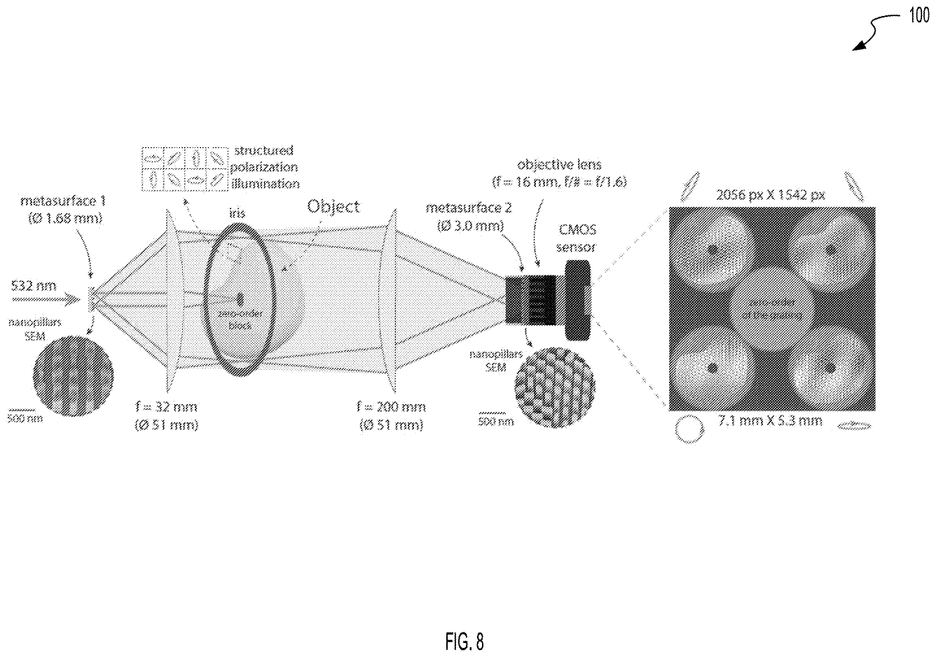

FIG. 8 illustrates a 4f imaging system (e.g., system 100). The 4f imaging system can be used to image the Mueller matrix of an object. The 4f imaging system can be designed to give control over the spatial and angular magnification and demagnification of the fields to completely image the object onto the spatial extent of the CMOS-sensor. The sizes and dimensions of the metasurfaces, CMOS-sensor, the imaging optic, and the distances between them, can be chosen to eliminate the need of a 4f system, depending on the application. The lenses in the 4f system can also be replaced by metalenses for a flat optic implementation. The object can be placed in the Fourier-plane, conjugate to both metasurface 1 and metasurface 2.

A light source can irradiate the metasurface 1 with unstructured light which is diffracted by the metasurface 1 into structured light. The structured light may have structured polarization illumination that has eight different polarizations in eight different locations to make up a pixel. The structured light irradiates the object at different pixels such that the eight different polarizations repeat across the object. Each pixel may be separately imaged by the eight different polarizations.

An iris and a zero-order beam block (e.g., circular black Acktar tape on a glass substrate) can be placed in the Fourier plane to limit the field-of-view (FOV) and block the background zeroth order light, respectively. The object, now in the far-field of metasurface 1, can interact with the structured polarization illumination. The resulting fields, in transmission and/or in reflection, can be imaged by the full-Stokes camera to retrieve the complete Mueller matrix image.

The reconstruction accuracy of the Mueller matrix image can be related to the accuracy of the full-Stokes camera. A robust metasurface full-Stokes camera can be designed and calibrated before introducing it into the Mueller matrix imaging setup. The metasurface full-Stokes camera can include metasurface 2, an imaging optic, and a CMOS-sensor. Metasurface 2 can function as both a diffraction grating (e.g., to split amplitudes), and an analyzer to simultaneously analyze for polarization states in different diffraction orders. In particular, metasurface 2 can analyze for four polarization states (e.g., that make up the edges of a tetrahedron inscribed within the Poincare sphere), in the first four off-axis diffraction orders.

In some embodiments, the metasurface 2 diffracts light from the object onto separate polarizations in different directions which are sensed by different portions of the CMOS-sensor. The different portions of the CMOS-sensor correspond to different polarizations of light such that the intensity of light on the different portions correspond to the amount of different portions of light for each pixel.

When a scene, extended over some FOV, is incident on metasurface 2, the separately analyzed copies of the scene in the four diffraction orders can be imaged onto a CMOS-sensor using an imaging optic. The 4-element Stokes vector can include at least four measurements to be fully determined (e.g., at each pixel), hence the use of four diffraction orders. If the metasurface grating is designed to analyze for the four polarization states \vec{S}_{A}, \vec{S}_{B}, \vec{S}_{C}, \vec{S}_{D}, then given a incident spatially varying Stokes vector \vec{S}ₒᵤₜ, the 4-element intensity vector (e.g., a vector of images) \vec{I}ₒᵤₜ(m, n) can be written as Equation 5:

$${\overbrace{( \begin{matrix}{I}_{out , A} ( m , n ) \\ {I}_{out , B} ( m , n ) \\ {I}_{out , C} ( m , n ) \\ {I}_{out , D} ( m , n )\end{matrix} )}}^{{\vec{I}}_{out} ( m , n )} = {\overbrace{( \begin{matrix}- {\vec{S}}_{A} - \\ - {\vec{S}}_{B} - \\ - {\vec{S}}_{C} - \\ - {\vec{S}}_{D} -\end{matrix} )}}^{\hat{A}} {\overbrace{( \begin{matrix}{\vec{S}}_{out , 0} ( m , n ) \\ {\vec{S}}_{out , 1} ( m , n ) \\ {\vec{S}}_{out , 2} ( m , n ) \\ {\vec{S}}_{out , 3} ( m , n )\end{matrix} )}}^{{\vec{S}}_{out} ( m , n )} \qquad ( 5 )$$

where Â is referred to as the instrument matrix.

Using Equation 5, \vec{S}ₒᵤₜ can be determined by using the inverse of the instrument matrix, Â⁻¹. \vec{S}ₒᵤₜ can be determined pixel by pixel at each (m, n) over the entire FOV. The instrument matrix Â can be experimentally determined through a thorough calibration, to calibrate out discrepancies between the ideal design, and its practical implementation by metasurface 2.

The 4f imaging system can be used to image the Mueller matrix of the object, which can be placed in the Fourier plane, conjugate to both metasurface 1 and metasurface 2. Metasurface 1 can produce structured polarized light which can illuminate the object, and metasurface 2 can diffract and simultaneously analyze the resulting fields which can then be imaged onto the CMOS-sensor. The iris in the Fourier-domain can be placed to limit the FOV, and the zero-order block can be placed to prevent the strong background laser light from saturating the sensor.

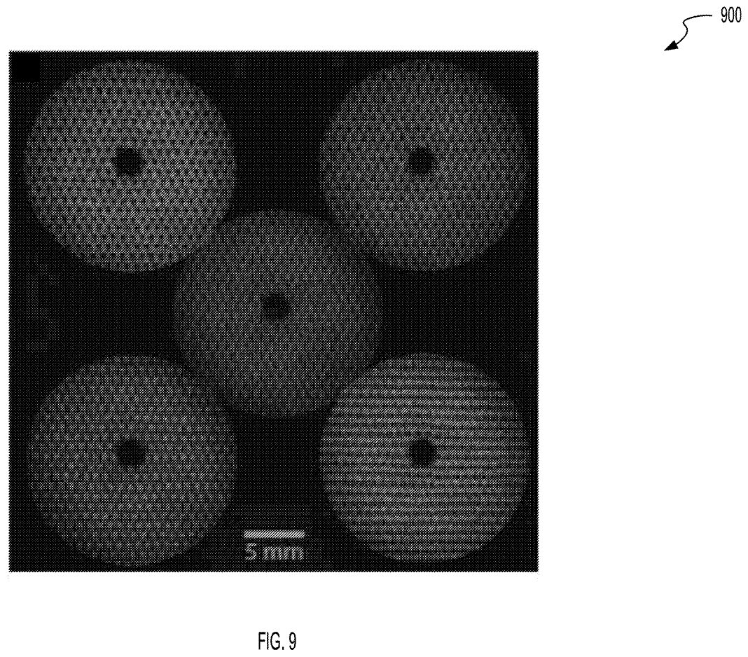

FIG. 9 illustrates an image 900 produced by the system of FIG. 8. FIG. 8 shows the raw grayscale image output by the system 100, in the case of no object, or simply air. The circular edges of the iris and the circular beam block can be seen. The iris, functioning as a field stop, can limit the FOV and can prevent the scenes centered on different diffraction orders from overlapping with each other. The zeroth order beam block can prevent the strong background laser light from propagating through the system, and saturating the sensor. FIG. 9 shows the raw measured image produced by the system in the case of no object. The periodic checkerboard and grid-like patterns can correspond to the spatially varying incident polarization. This image of air, which has a Mueller matrix of identity, can be used for calibration.

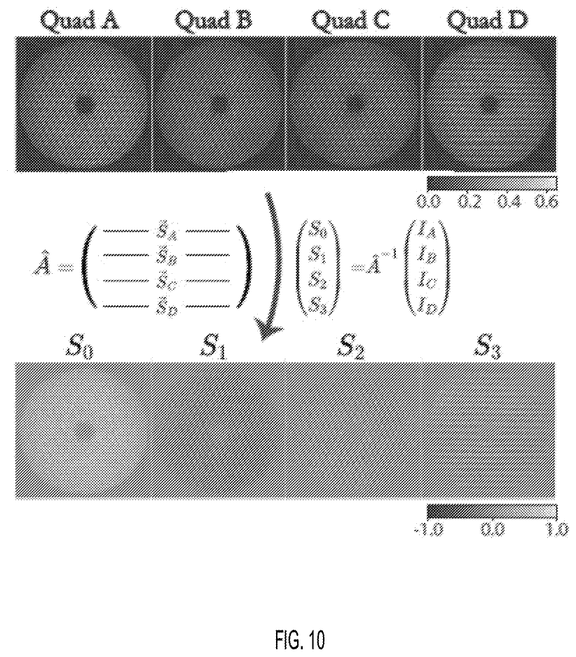

The raw image can be processed into a full-Stokes image using the instrument matrix Â, as shown in FIG. 10. FIG. 10 illustrates the full-Stokes image. The raw images in the four quadrants of the CMOS-sensor can be converted to the corresponding full-Stokes image by using the instrument matrix, which is predetermined in a separate, full-Stokes calibration.

The complete Mueller matrix image can be computed through amplitude demodulation of the full-Stokes image. Different methods and algorithms can be used to demodulate a signal from a carrier-wave. For example, the product detector method can be used. This method can be best understood by a simple 1D example. Imagine a carrier wave cos kx+φ amplitude modulated by a slowly varying signal of interest A(x) resulting in the output signal A(x) cos(kx+φ). If the output signal is multiplied by the original carrier wave signal, the signal

$$A ( x ) {cos}^{2} ( kx + ϕ ) = \frac{A ( x )}{2} + \frac{A ( x ) cos ( 2 ( kx + ϕ ) )}{2}$$

can be obtained. Applying a low pass filter, centered on the origin and with a radius of k/2, on the spectrum (e.g., Fourier spectrum) of A(x) cos²(kx+φ), gives the spectrum of

$$\frac{A ( x )}{2} ,$$

given that the spectrum of A(x) lies within the k/2 radius. Thus, the desired signal A(x) can be fully and completely retrieved. This method can require the knowledge of the carrier wave, which can necessitate a reference measurement. In this case, the air image can serve as a reference measurement, since air has a Mueller matrix (e.g., spatially uniform Mueller matrix) of identity. The reference measurement can also help to calibrate out any variations in the amplitude of our structured polarization illumination.

Metasurface 1 can be designed to produce spatially varying polarization, with uniform intensity. There can be variations (e.g., fast variations, slow variations) in intensity across the hologram that can be calibrated out. The fast intensity variations can be clipped off by the low pass filter, and though they can contribute to aliasing, their contribution is small, if not negligible. In the case of slow intensity variations, the carrier can be defined to be ∝(x) cos kₓ+φ where ∝(x) is a slowly varying amplitude envelope. For a signal of interest A(x), the amplitude modulated signal can be written as A(x)∝(x) cos(kₓ+φ). The demodulation described above can be carried out as-is, resulting in the retrieved signal

$$\frac{A ( x ) {∝}^{2} ( x )}{2} ,$$

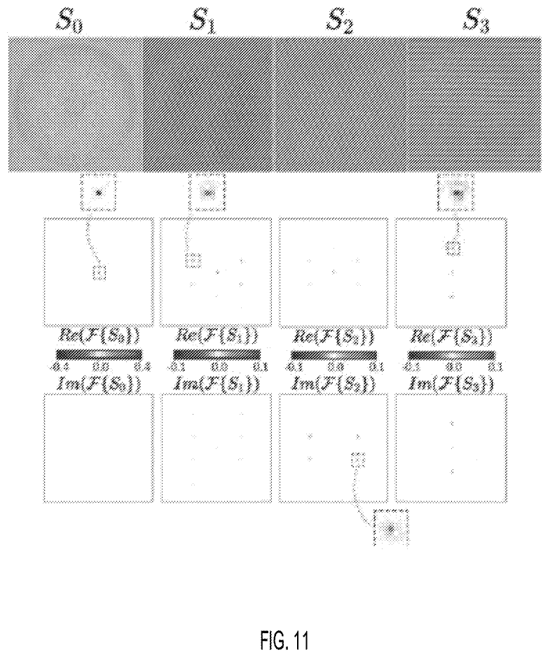

which, when divided by ∝² (x), gives us the signal of interest A(x). This 1D description of amplitude demodulation can be extended to 2D, to demodulate the 16 Mueller component images, from the 4 Stokes component images. To prepare the air Stokes image as a reference measurement to be used in demodulation, the parts of the image with no signal (corresponding to the regions where light is blocked from the iris and the beam block) can be filled through extrapolation as shown in FIG. 11. This can ensure that the reference Stokes components are close to the desired sinusoid signals. This can be seen in the Fourier spectra of the reference Stokes components. Approximate delta functions can be seen in the expected channel locations as shown in FIG. 11. FIG. 11 illustrates reference images for amplitude demodulation. The region with no signal (e.g., corresponding to the iris and zeroth order block) can be filled via extrapolation. This can result in images or signals which are close to 2D sinusoids. These images can then be used as reference images for amplitude demodulation. The Fourier spectra of these reference images can be plotted. They can be close to the expected delta-like functions.

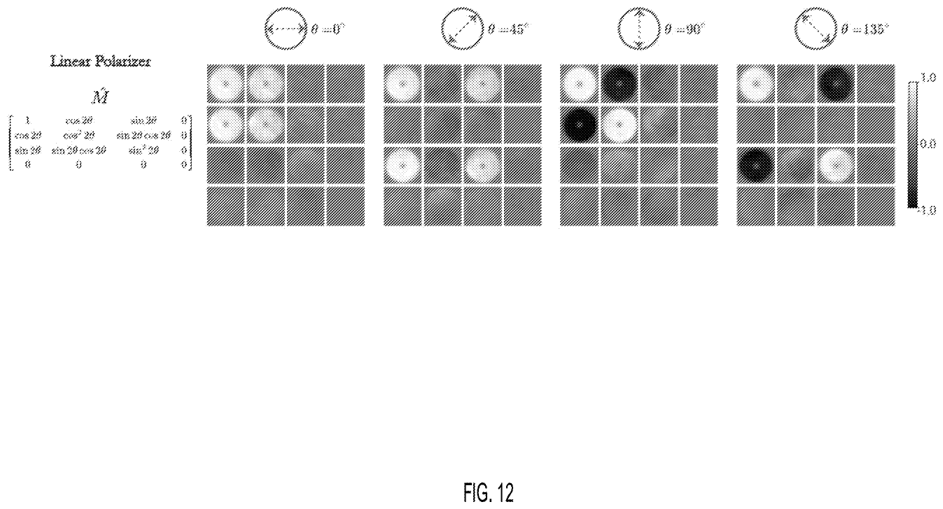

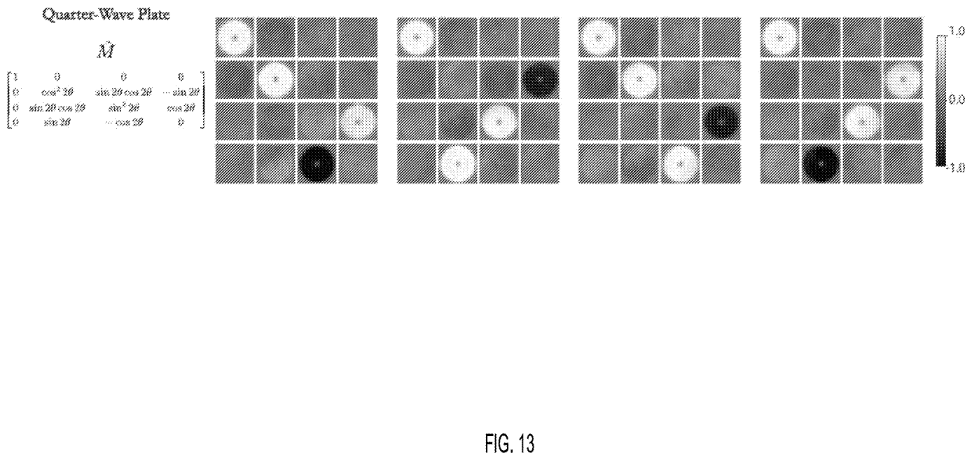

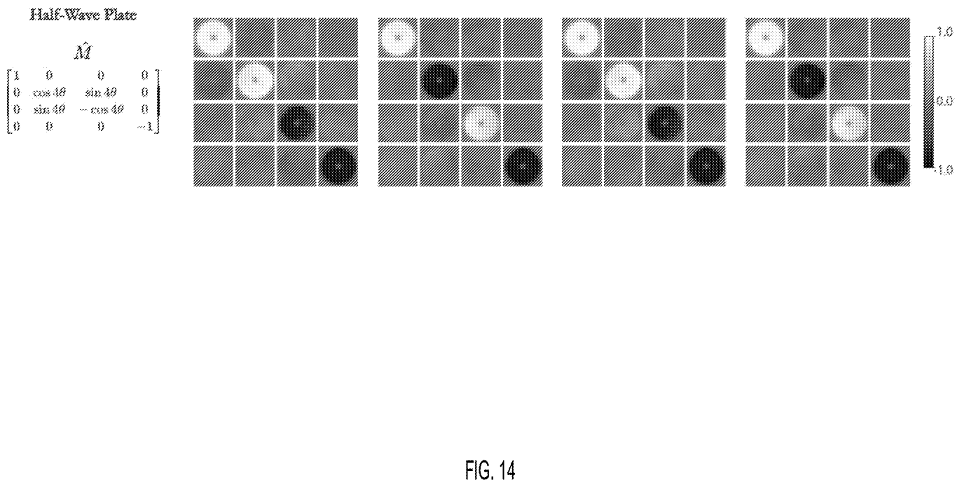

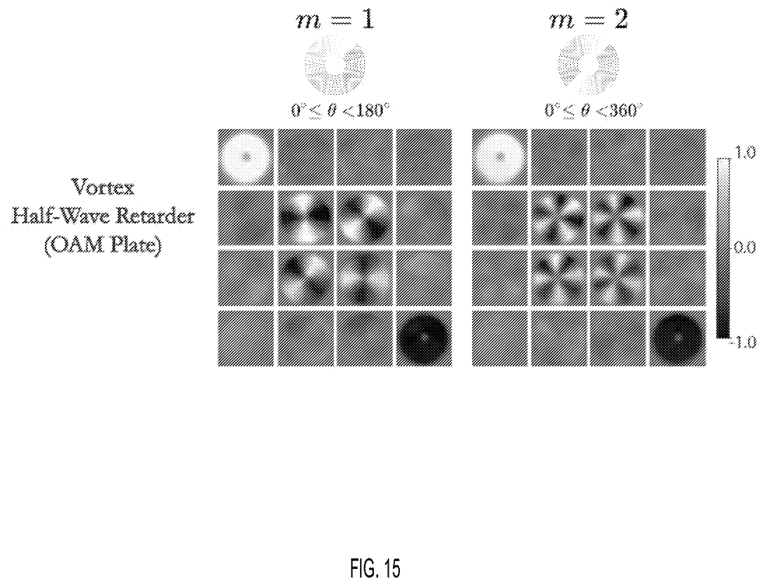

The system 100 can be used to image a variety of polarization optics, such as polarizers, waveplates and orbital-angular-momentum (OAM) plates. The results are shown in FIGS. 12-15. A linear film polarizer is imaged in FIG. 12, a zero-order quarter-waveplate (QWP) is imaged in FIG. 13, and a zero-order half-waveplate (HWP) is imaged in FIG. 14, each in four different orientations, resulting in 12 different Mueller matrix images. FIG. 12 illustrates measured Mueller matrix images of a thin-film linear polarizer. FIG. 12 illustrates measured Mueller matrix images of a thin-film linear polarizer at four different transmission-axis orientations (θ). Also listed is the Mueller matrix (\hat{M}) of the linear polarizer as a function of θ. FIG. 13 illustrates measured Mueller matrix images of a zero-order quartz quarter-wave plate. FIG. 13 illustrates measured Mueller matrix images of a zero-order quartz quarter-wave plate at four different fast-axis orientations (θ). Also listed is the Mueller matrix (\hat{M}) of the quarter-wave plate as a function of θ. FIG. 14 illustrates measured Mueller matrix images of a zero-order quartz half-wave plate. FIG. 14 illustrates measured Mueller matrix images of a zero-order quartz half-wave plate at four different fast-axis orientations (θ). Also listed is the Mueller matrix (M) of the half-wave plate as a function of θ. The expected (e.g., theoretical) Mueller matrix responses of these optics as functions of different orientations (θ), are also listed in FIGS. 12-14. A good correspondence between the measured Mueller matrix images and the expected responses can be seen. Furthermore, the regions where the light is blocked by the iris and the beam block, having Mueller matrix values of zero, can be identified. The edges of the iris and the circular beam block, in a way, provide additional spatial information to image and test the system 100 beyond just the polarization active region of the optics. A Mueller matrix can be normalized with respect to its Moo component. For a Mueller matrix image, normalizing each pixel with respect to its Moo component can result in the loss of important spatially varying intensity information. Therefore, all the components in the Mueller matrix image can be normalized by the maximum pixel value of the M₀₀ image. Following normalization, saturated pixels, with nonphysical values beyond ±1, can be clipped at ±1. Saturated pixels can have values very close to +1, as seen in error analyses. Two OAM plates can be imaged, results of which are shown in FIG. 15. In particular, these can be vortex half-wave retarders made of liquid crystal polymers, with a fixed retardance of Tt, but a fast-axis that rotates azimuthally over the area of the optic. This spatial variation is unambiguously captured in the M₁₁, M₁₂, M₂₁, and M₂₂ and components in the two Mueller images shown in FIG. 15. FIG. 15 illustrates measured Mueller matrix images of a half-wave plate. FIG. 15 illustrates measured Mueller matrix images of two, m=1 and m=2, vortex half-wave retarders (e.g., OAM plates).

The full-Stokes camera can be calibrated and reference measurements can be performed for the structured polarization illumination. There can be sources of error that can degrade the quality of the final image. Contributions from high spatial frequency components from, for example, the sharp edges of the iris and the beam block, can result in aliasing. However, these contributions can be negligible. A main source of error can be the channel cross-talk. The Stokes components defined in Equation 2 can be all orthogonal to each other. In practice, when implemented by the metasurface, the resulting reference Stokes components (FIG. 11) may not completely orthogonal. This can result in mixing of the spectra of different Mueller components, or cross-talk.

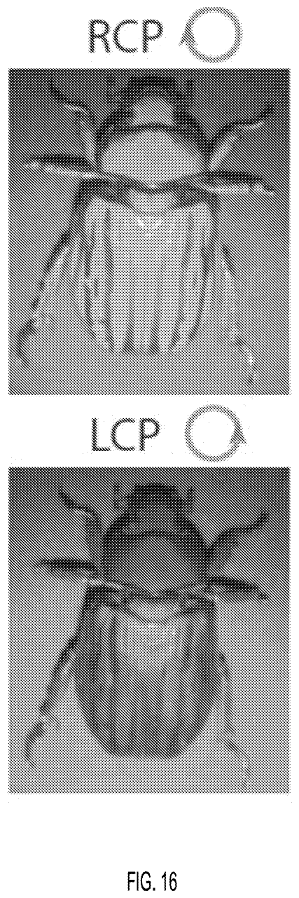

The system 100 for imaging in reflection. The Chrysina gloriosa, or the chiral beetle can be imaged. The chiral beetle can have different optical responses for the two circular polarizations. As shown in FIG. 16, parts of the exoskeleton or shell of the chiral beetle appear bright under right-circular polarization (RCP) illumination and dark under left-circular polarization (LCP) illumination (for the green wavelength). FIG. 16 illustrates a chiral beetle illuminated by right circularly polarized light and left circularly polarized light. The beetle can be imaged by a digital single-lens reflex camera (DSLR) camera. Thus, the shell of the chiral beetle can be analyzed for circular polarization. Without the system 100, the state-of-polarization reflecting off of the shell cannot be concluded from these two intensity measurements. The intensity images, juxtaposed for comparison, show that the beetle exhibits a different optical response for the two circular polarizations.

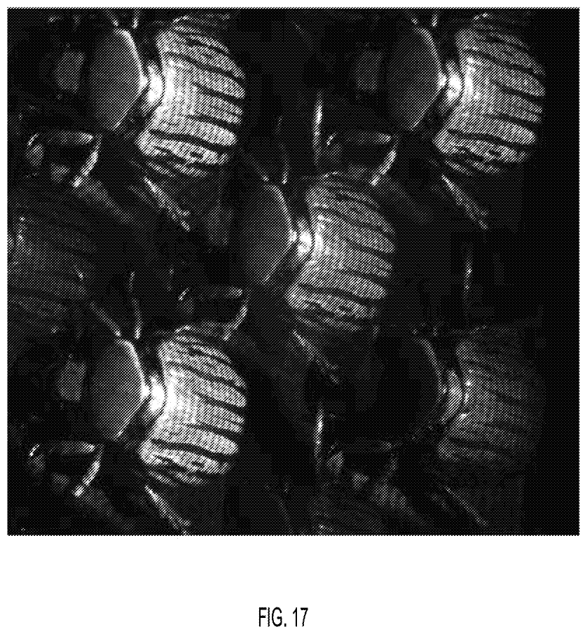

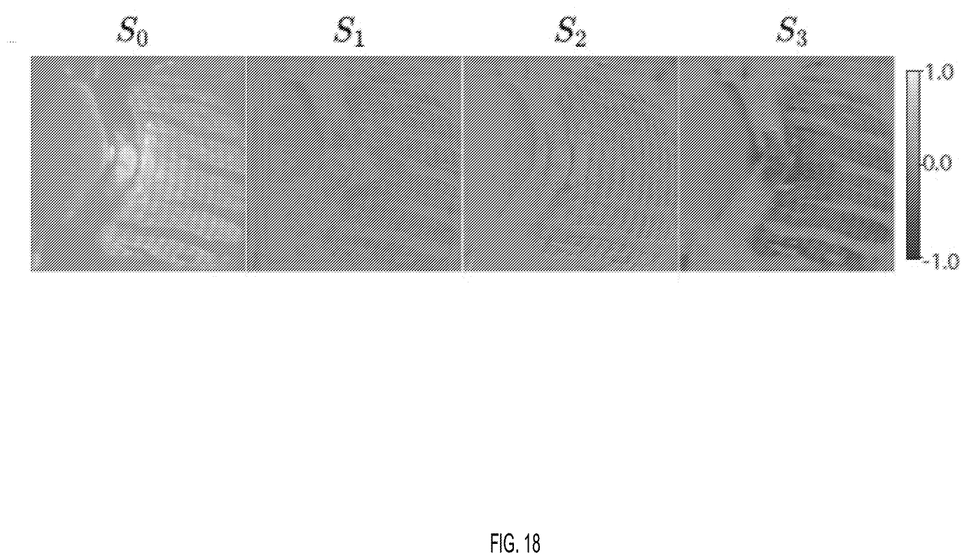

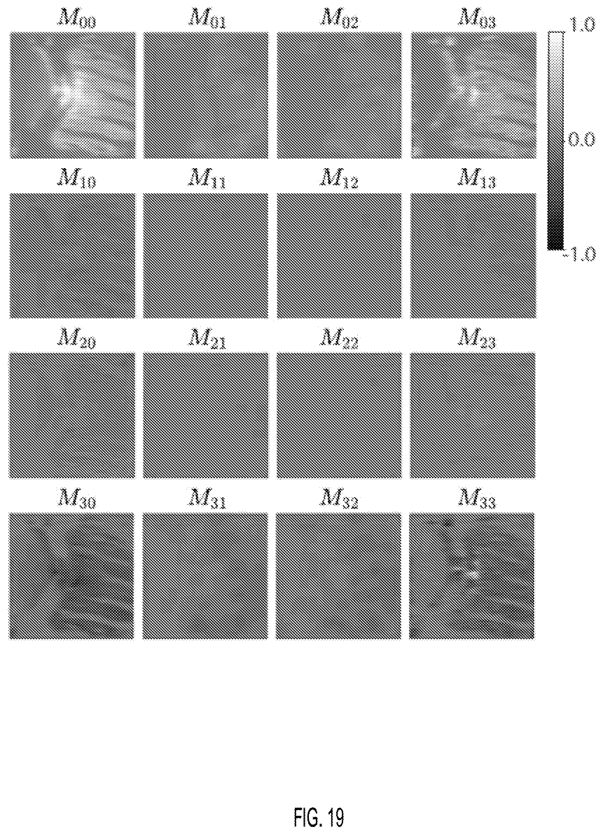

The system 100, set up in reflection, allows for the determination of the exact polarization properties of the shell of the chiral beetle as shown in FIGS. 17-19. FIG. 17 illustrates a raw image of a chiral beetle captured using Mueller matrix imaging. FIG. 18 illustrates a full-Stokes image computed from the raw image of FIG. 17. FIG. 18 illustrates the resulting full-Stokes image computed from the raw image, using the instrument matrix Â (Equation 5). FIG. 19 illustrates a Mueller matrix image from the full-Stokes image of FIG. 18. A suitable reflective object for reference Stokes measurements in reflection may not be determined due to the curvature of the beetle's shell as evident in the raw image (FIG. 17). Therefore, to compute the Mueller matrix image (FIG. 19), from the Stokes image (FIG. 18), a reference free method can be used by using contextual knowledge and some simplifying assumptions. From the resulting Mueller matrix image of the chiral beetle (FIG. 19), it can be determined that its shell behaves as a homogenous circular polarizer (e.g., it not only analyzes for circular polarization, but also generates circular polarization in reflection). Interesting spatial features such as the striae (e.g., characteristic dark lines on the shell of the chiral beetle) can be resolved in the final Mueller matrix image (FIG. 19), by using a rectangular low-pass filter (e.g., assigning more bandwidth along one axis in comparison to the other). FIG. 19 illustrates the resulting Mueller matrix image from the full-Stokes image, which can be computed (e.g., demodulated and normalized) using a reference free method. The Mueller matrix image of the chiral beetle, can have spatially resolved features such as the size and shape of the shell, the characteristic stride on the shell. The shell of the chiral beetle can function as a homogeneous circular polarizer.

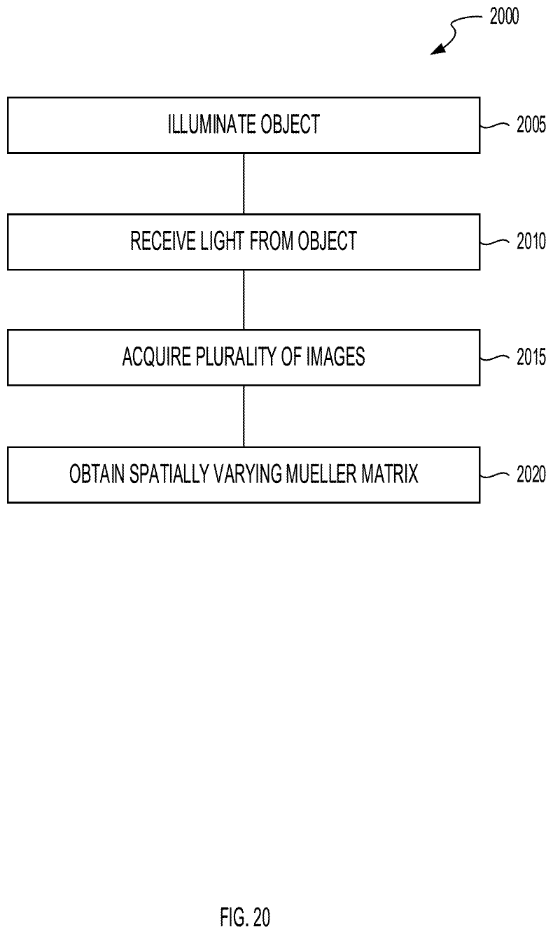

FIG. 20 illustrates a method 2000 of Mueller matrix imaging. The method 2000 can include illuminating an object (BLOCK 2005). The method 2000 can include receiving light from the object (BLOCK 2010). The method 2000 can include acquiring a plurality of images (BLOCK 2015). The method 2000 can include obtaining a spatially varying Mueller matrix (BLOCK 2020).

The method 2000 can include illuminating the object (BLOCK 2005). For example, the method 2000 can include illuminating the object by the polarization state generator. The method 2000 can include illuminating the object with a spatially varying polarization distribution. The method 2000 can include illuminating, by the polarization state generator, the object with a spatially varying polarization distribution. The spatially varying polarization distribution 125 can be equal to or proportional to

$$( \begin{matrix}1 \\ \sqrt{\frac{2}{3}} cos ( 0.5 m π ) cos ( n π ) \\ \sqrt{\frac{2}{3}} sin ( 0.5 m π ) cos ( n π ) \\ \sqrt{\frac{1}{3}} cos ( m π )\end{matrix} ) ,$$

where (m, n) are discrete spatial coordinates. The spatially varying polarization distribution can have a uniform intensity. The spatially varying polarization distribution can have a non-uniform intensity. The spatially varying polarization distribution can include a plurality of polarization states. The spatially varying polarization distribution can include at least four different polarization states. The polarization state generator can include a metasurface.

The method 2000 can include receiving light from the object (BLOCK 2010). The method 2000 can include receiving, by the polarization state analyzer, light from the object. The polarization state analyzer can include a metasurface.

The method 2000 can include acquiring a plurality of images (BLOCK 2015). The method 2000 can include acquiring the plurality of images from the polarization state analyzer. The method 2000 can include acquiring the plurality of images from the polarization state analyzer in a single measurement in time. The method 2000 can include acquiring, by at least one processor, the plurality of images from the polarization state analyzer in a single measurement in time. The plurality of images can include sixteen images corresponding to the spatially varying Mueller matrix. The at least one processor can include a CMOS sensor.

The method 2000 can include obtaining a spatially varying Mueller matrix (BLOCK 2020). The method 2000 can include obtaining the spatially varying Mueller matrix. The method 2000 can include obtaining, by the at least one processor, the spatially varying Mueller matrix. The spatially varying Mueller matrix can include one or more polarization properties of the object.

The systems and methods of the present disclosure can include the principles behind designing and building a compact, single-shot and complete Mueller matrix imaging system. The system can image objects in both transmission and reflection. By designing larger metasurfaces, using higher NA lenses and higher resolution sensors, the resolution of the Mueller matrix imaging system can be pushed to its theoretical limit. More sophisticated calibration methods and reconstruction algorithms, for instance by custom designing the Fourier filters, can be used to further reduce errors from aliasing and cross-talk. Super-resolution techniques, and machine learning assisted reconstruction can also be used to image beyond the band-limits of the filters. Furthermore, the structured polarization illumination can be used to probe the depth profile of the object in addition to its polarization properties, for polarization-resolved depth sensing. For example, the curvature of the lines reflecting off of the shell of the chiral beetle in FIG. 17, could be used to estimate its curvature.

The systems and methods of the present disclosure can empower Mueller matrix imaging applications in fields in biomedicine, for example, in cancer detection. The systems and methods of the present disclosure can be used for depth-resolved Mueller matrix confocal microscopy and polarimetric endoscopic imaging. The potential of Mueller matrix imaging in saccharimetry (e.g., the process of measuring the amount of sugar in a sample) can be useful to food, pharmaceutical, and biomedical industries. Mueller matrix imaging could also be of great use in the characterization of nanostructures, metasurfaces, and metamaterials. Consumer electronics applications, such as eye-tracking in augmented and virtual reality headsets, and facial recognition in smartphones, can benefit from the small form factor of the present system for complete and single-shot Mueller matrix imaging. Furthermore, this system, given its superior time resolution and flexibility, could be useful in generating large Mueller matrix datasets to train neural networks for a myriad of machine learning classification applications. Beyond technological applications, this system could be of consequence in fundamental science, such as in the detection of the birefringence of vacuum in the presence of intense electric and magnetic fields (e.g., as theorized by quantum electrodynamics), in the study of 3D polarization states of light, and in the research of both short wavelength (e.g., X-ray) and long wavelength (e.g., terahertz) polarimetry.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources. The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, microprocessors, and any one or more processors of a digital computer. A processor can receive instructions and data from a read only memory or a random access memory or both. The elements of a computer are a processor for performing actions in accordance with instructions and one or more memory devices for storing instructions and data. A computer can include, or be operatively coupled to receive data from or transfer data to, or both, one or more mass storage devices for storing data, e.g., magnetic, magneto optical disks, or optical disks. A computer need not have such devices. Moreover, a computer can be embedded in another device, e.g., a personal digital assistant (PDA), a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The implementations described herein can be implemented in any of numerous ways including, for example, using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to or receive communications from other devices. The display unit(s) may be provided, for example, to allow a user to view various information in connection with execution of the instructions. The user input device(s) may be provided, for example, to allow the user to make manual adjustments, make selections, enter data or various other information, or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the solution discussed above. The computer readable medium or media can be transportable, such that the program or programs stored thereon can be loaded onto one or more different computers or other processors to implement various aspects of the present solution as discussed above.

The terms “program” or “software” are used herein to refer to any type of computer code or set of computer-executable instructions that can be employed to program a computer or other processor to implement various aspects of embodiments as discussed above. One or more computer programs that when executed perform methods of the present solution need not reside on a single computer or processor, but may be distributed in a modular fashion amongst a number of different computers or processors to implement various aspects of the present solution.

Computer-executable instructions may be in many forms, such as program modules, executed by one or more computers or other devices. Program modules can include routines, programs, objects, components, data structures, or other components that perform particular tasks or implement particular abstract data types. The functionality of the program modules can be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A system, comprising:
a polarization state generator comprising a metasurface and configured to illuminate an object with a spatially varying polarization distribution;
a polarization state analyzer configured to receive light from the object; and
at least one processor configured to:
acquire a plurality of images from the polarization state analyzer in a single measurement in time; and
obtain a spatially varying Mueller matrix comprising one or more polarization properties of the object.

2. The system of claim 1, wherein the spatially varying polarization distribution is equal or proportional to
$$( \begin{matrix}1 \\ \sqrt{\frac{2}{3}} cos ( 0.5 m π ) cos ( n π ) \\ \sqrt{\frac{2}{3}} sin ( 0.5 m π ) cos ( n π ) \\ \sqrt{\frac{1}{3}} cos ( m π )\end{matrix} ) ,$$
wherein (m, n) are discrete spatial coordinates.

3. The system of claim 1, wherein the light comprises polarized light.

4. The system of claim 1, wherein the polarization state analyzer comprises a metasurface.

5. The system of claim 1, wherein the spatially varying polarization distribution has a uniform intensity.

6. The system of claim 1, wherein the spatially varying polarization distribution has a non-uniform intensity.

7. The system of claim 1, wherein the plurality of images comprises sixteen images corresponding to the spatially varying Mueller matrix.

8. The system of claim 1, wherein the spatially varying polarization distribution comprises a plurality of polarization states.

9. The system of claim 1, wherein the spatially varying polarization distribution comprises at least four different polarization states.

10. The system of claim 1, wherein the at least one processor comprises a complementary metal oxide semiconductor (CMOS) sensor.

11. A method, comprising:
illuminating, by a polarization state generator, an object with a spatially varying polarization distribution;
receiving, by a polarization state analyzer, light from the object;
acquiring, by at least one processor, a plurality of images from the polarization state analyzer in a single measurement in time; and
obtaining, by the at least one processor, a spatially varying Mueller matrix comprising one or more polarization properties of the object.

12. The method of claim 11, wherein the spatially varying polarization distribution is equal or proportional to
$$( \begin{matrix}1 \\ \sqrt{\frac{2}{3}} cos ( 0.5 m π ) cos ( n π ) \\ \sqrt{\frac{2}{3}} sin ( 0.5 m π ) cos ( n π ) \\ \sqrt{\frac{1}{3}} cos ( m π )\end{matrix} ) ,$$
wherein (m, n) are discrete spatial coordinates.

13. The method of claim 11, wherein the polarization state generator comprises a metasurface.

14. The method of claim 11, wherein the polarization state analyzer comprises a metasurface.

15. The method of claim 11, wherein the spatially varying polarization distribution has a uniform intensity.

16. The method of claim 11, wherein the spatially varying polarization distribution has a non-uniform intensity.

17. The method of claim 11, wherein the plurality of images comprises sixteen images corresponding to the spatially varying Mueller matrix.

18. The method of claim 11, wherein the spatially varying polarization distribution comprises a plurality of polarization states.

19. The method of claim 11, wherein the spatially varying polarization distribution comprises at least four different polarization states.

20. The method of claim 11, wherein the at least one processor comprises a complementary metal oxide semiconductor (CMOS) sensor.
